(19) United States
(12) Patent Application Publication
(10) Pub. No.: US 2013/0138869 A1
(43) Pub. Date: May 30, 2013

(54) NONVOLATILE MEMORY AND MEMORY DEVICE INCLUDING THE SAME

(71) Applicant: DONG-HUN KWAK, HWASEONG-SI (KR)

(72) Inventor: DONG-HUN KWAK, HWASEONG-SI (KR)

(21) Appl. No.: 13/599,076

(22) Filed: Aug. 30, 2012

(30) Foreign Application Priority Data
Nov. 28, 2011 (KR) 10-2011-0125076

(51) Int. Cl. G06F 12/02

(52) U.S. Cl. 711/103; 711/E12.008

(57) ABSTRACT

A nonvolatile memory has a first memory block including a plurality of sub memory blocks stacked in a direction perpendicular to a substrate, and a second memory block including a plurality of sub memory blocks stacked in a direction perpendicular to the substrate, the second memory block being parallel to the first memory block. Management data unchanged after it is programmed once is stored in at least one sub memory block of the first memory block and main data is stored in sub memory blocks of the second memory block. Meta data may be stored in a sub memory block of the first memory block of in any memory block that does not contain the management data.

### PRIORITY STATEMENT

This U.S. non-provisional patent application claims priority under 35 U.S.C. §119 of Korean Patent Application No. 10-2011-0125076, filed on Nov. 28, 2011, the entire contents of which are hereby incorporated by reference.

### BACKGROUND

The inventive concept relates to semiconductor memory devices. More particularly, the inventive concept relates to nonvolatile semiconductor memory devices.

Memories that employ semiconductor materials such as silicon (Si), germanium (Ge), gallium arsenide (GaAs), indium phospide (InP), or the like may be classified as either a volatile memory or a nonvolatile memory.

A volatile memory loses its stored data when the power supplied to the memory is interrupted. Examples of volatile memories are a static RAM (SRAM), a dynamic RAM (DRAM), and a synchronous DRAM (SDRAM). On the other hand, a nonvolatile memory can maintain its stored data even when the power supplied to the memory is interrupted. Examples of a nonvolatile memory are a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (RRAM), and a ferroelectric RAM (FRAM). Furthermore, flash memories may be classified as either a NOR-type or NAND-type of flash memory.

With respect to these examples of nonvolatile memories, a three-dimensional memory cell array is currently under study with the aim to improve the integration density of a flash memory.

### SUMMARY

According to an aspect of the inventive concept, there is provided a nonvolatile memory storing main data, management data, and meta data, and having memory blocks including at least one main memory block and at least one special memory block, and in which each of the memory blocks comprise sub memory blocks stacked on a substrate, each of the sub memory blocks comprises an array of memory cells, the memory cells of one of the sub memory blocks of the at least one special memory block are pre-programmed with the management data, the memory cells of at least one of the sub memory blocks of the at least one main memory block are configured with the main data, and the memory cells of one of the sub memory blocks of one of the memory blocks that contains no main data are configured with the meta data.

According to another aspect of the inventive concept, there is provided a memory device including a nonvolatile memory having at least one main memory block and a special memory block, and a controller operative to store main data received from outside the memory device in the nonvolatile memory, and in which each of the memory blocks includes a plurality of sub memory blocks stacked in a direction perpendicular to a substrate, the nonvolatile memory is configured such that data stored in any one of the sub memory blocks constituting each respective one of the memory blocks can be erased independently of the data stored in each other sub memory block constituting the respective memory block and such that only management data is stored in at least one of the sub memory blocks of the special memory block, and the controller is configured with a map that allows it to store any of the main data received from outside the memory device in the at least one main memory block but prevents it from storing any of the main data received from outside the memory device in the special memory block.

According to still another aspect of the inventive concept, there is provided a device that includes a nonvolatile memory, and which comprises a memory cell array constituting the nonvolatile memory, an address decoder that decodes logical addresses accompanying main data received from outside the memory device, and an address map, and in which the memory cell array has main memory blocks and at least one special memory block, each of the main and special memory blocks includes a plurality of sub memory blocks stacked on a substrate in a direction perpendicular to the substrate and each of which has a plurality of memory cells, the memory cells of at least one of the sub memory blocks of the at least one special memory block is pre-programmed with management data that controls management of the nonvolatile memory, and the address map maps the logical addresses to physical addresses of all of the sub memory blocks other than the at least one of the sub memory blocks that comprises the pre-programmed memory cells configured with management data.

### BRIEF DESCRIPTION OF THE DRAWINGS

Preferred embodiments of the inventive concept will be described below in more detail with reference to the accompanying drawings.

FIG. 1 is a block diagram of a memory device in general.

FIG. 2 is a block diagram of an example of the memory device illustrated in FIG. 1.

FIG. 3 is a block diagram of a memory cell array of the memory device shown in FIG. 1.

FIG. 4 is a perspective view of a cross section of one of the memory blocks of the array illustrated in FIG. 3.

FIG. 5 is a cross-sectional view of the memory block.

FIG. 6 is an enlarged view of one of the cell transistors of the memory block illustrated in FIGS. 4 and 5.

FIG. 7 is an equivalent circuit diagram of the memory block.

FIG. 8 is a flow chart of a method of storing data in the memory device illustrated in FIG. 1.

FIG. 9 is a conceptual drawing illustrating a mapping relation between a logical address received from a host and the memory blocks of the memory cell array.

FIG. 10 is a table showing to type of data being stored in first through zth memory blocks of the memory cell array.

FIG. 11 is a conceptual drawing illustrating a first embodiment of a method by which management data and main data are stored.

FIG. 12 is a conceptual drawing illustrating a second embodiment of a method by which management data and main data are stored.

FIG. 13 is a conceptual drawing illustrating a third embodiment of a method by which management data and main data are stored.

FIG. 14 is a conceptual drawing illustrating a fourth embodiment of a method by which management data and main data are stored.

FIG. 15 is a block diagram of another example of the memory device illustrated in FIG. 1.

FIG. 16 is a block diagram of a computing system including the memory device illustrated in FIG. 15.

### DETAILED DESCRIPTION OF THE PREFERRED EMBODIMENTS

Various embodiments and examples of embodiments of the inventive concept will be described more fully hereinafter with reference to the accompanying drawings. In the drawings, the sizes and relative sizes and shapes of elements, layers and regions, such as implanted regions, shown in section may be exaggerated for clarity. In particular, the cross-sectional illustrations of the semiconductor devices and intermediate structures fabricated during the course of their manufacture are schematic. Also, like numerals are used to designate like elements throughout the drawings.

It will also be understood that when an element or layer is referred to as being “on” or “connected to” another element or layer, it can be directly on or directly connected to the other element or layer or intervening elements or layers may be present. In contrast, when an element or layer is referred to as being “directly on” or “directly connected to” another element or layer, there are no intervening elements or layers present.

Other terminology used herein for the purpose of describing particular examples or embodiments of the inventive concept is to be taken in context. For example, the terms “comprises” or “comprising” when used in this specification specifies the presence of stated features or processes but does not preclude the presence or additional features or processes.

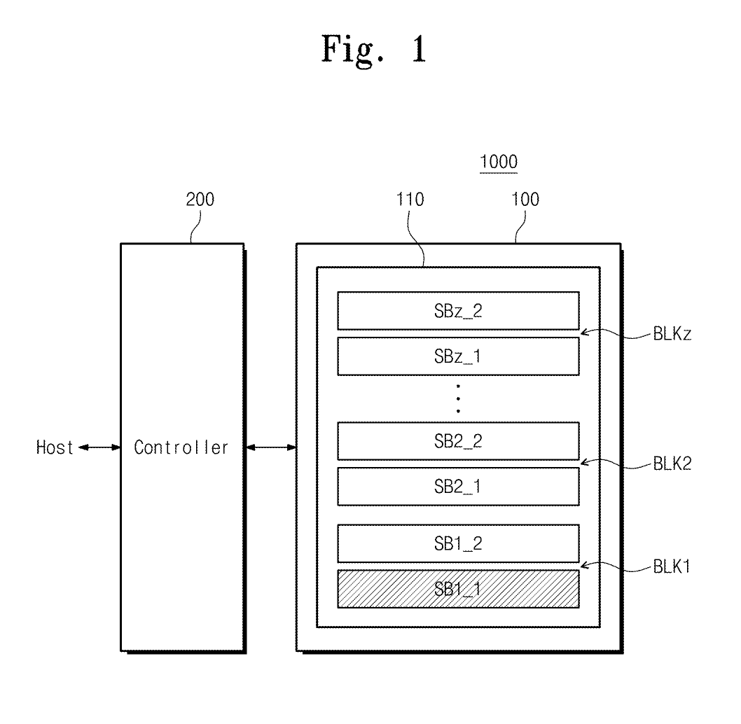

Referring to FIG. 1, a memory device 1000 includes a nonvolatile memory 100 and a controller 200. The nonvolatile memory 100 includes a memory cell array 110. The memory cell array 110 includes a plurality of memory blocks BLK1˜BLKz. Each of the memory blocks BLK1˜BLKz includes a plurality of sub memory blocks SB1_1, SB1_2, SB2_1, SB2_2, . . . , SBZ_1, SBz_2 that are stacked in a direction perpendicular to a substrate. In this respect, FIG. 1 illustrates that each memory block includes two sub memory blocks, as an example only. An erasure operation of the nonvolatile memory 100 is performed by a sub memory block unit. Program and read operations of the nonvolatile memory 100 are performed by a page unit.

The plurality of memory blocks BLK1˜BLKz is divided into at least one special memory block and a plurality of main memory blocks.

Each main memory block is a memory block that stores main data. Main data refers to data that is written in the nonvolatile memory 100 in response to a request from a host. Therefore, the main data may be text data, video data, audio data or data for executing all sorts of software such as operating system software or application programs.

The special memory block is a memory block configured with management data. More specifically, the management data may be stored in at least one sub memory block of the special memory block. For example, when the first memory block BLK1 is the special memory block, the management data may be stored in one sub memory block SB1_1 (as indicated by the shading using oblique lines) of the first memory block BLK1.

Management data refers to data for managing the memory device 1000. The management data is written in the nonvolatile memory 100 without a request from the host.

More specifically, management data refers to data that remains unchanged after it has been once programmed in a testing phase of the nonvolatile memory 100. The management data may be data that sets the operating environment of the memory device 1000, such as various algorithms for operating of the nonvolatile memory 100, data for executing an initial operation of the nonvolatile memory 100, E-Fuse data, or various algorithms for operating the controller 200. Management data also refers to all sorts of information pertaining to the nonvolatile memory 100 such as an encryption code required when the host certifies the nonvolatile memory 100 or the memory device 1000, and information identifying (representative of characteristics of) the nonvolatile memory 100.

Management data also refers to meta data generated by the controller 200 to manage the memory device 1000 after a test phase has been completed. Still further, management data may also include an address mapping table for mapping logical and physical addresses, wear-leveling information and data for recovery, i.e., management, of a bad memory block.

Referring still to FIG. 1, the controller 200 is coupled to the host and the nonvolatile memory 100 and constitutes an interface between the host and the nonvolatile memory 100. The controller 200 is configured to access the nonvolatile memory 100 in response to a request from the host, and to control read, program, erasure and background operations of the nonvolatile memory 100.

In an example of this embodiment, the controller 200 operates a flash translation layer (FTL). In general, when receiving a write request from the host, the controller 200 receives a logical address and main data. The controller 200 translates the logical address into a physical address according to the flash translation layer (FTL). The controller 200 transmits the translated physical address and the main data to the nonvolatile memory 100. The controller 200 manages an address mapping table storing a mapping relation (file pointers) between the logical address and the physical address.

According to one aspect of the inventive concept, management data is stored in at least one sub memory block of the special memory block, and the controller 200 is operative to store the main data in the main memory blocks. The controller may also be configured such that it will not store any of the main data in the special memory block. To this end, the controller 200 has a map of logical addresses and the physical addresses of those main memory blocks except the special memory block.

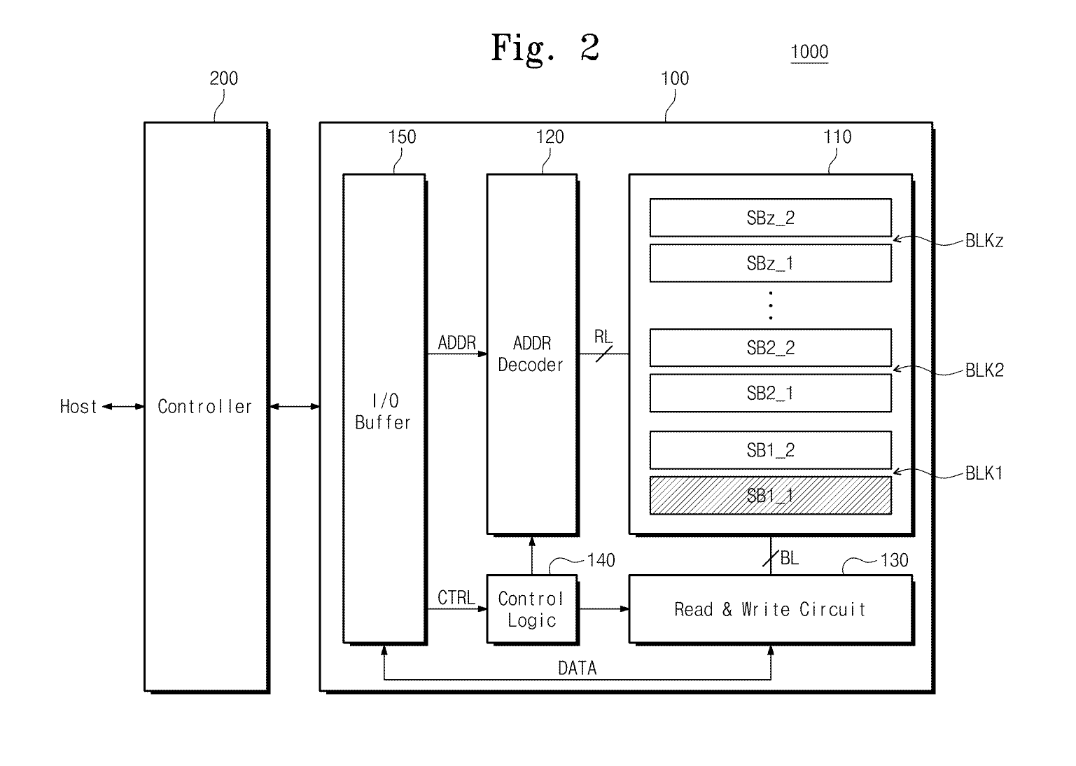

Referring to FIG. 2, the nonvolatile memory 100 of one example of the memory device 1000 includes not only the memory cell array 110, but also an address decoder 120, a read & write circuit 130, a control logic 140 and an input/output buffer (circuit) 150.

The memory cell array 110 is coupled to the address decoder 120 through row lines RL. The row lines RL includes string select lines, ground select lines and a plurality of word lines. The memory cell array 110 is coupled to the read & write circuit 130 through bit lines BL.

The address decoder 120 is coupled to the memory cell array 110, the control logic 140 and the input/output buffer 150. In this respect, the address decoder 120 operates under the control of the control logic 140. Generally speaking, the address decoder 120 receives any of numerous addresses ADDR from the input/output buffer 150, is configured to decode the received address into a block address, and is operative to select one of the memory blocks BLK1˜BLKz of the memory cell array 110 on the basis of the decoded block address.

More specifically, the address decoder 120 selects an appropriate one of the word lines according to the decoded row address, and applies a voltage to each of the row lines RL according to the decoded row address DA. The address decoder 120 is also configured to decode the received address ADDR into a column address, and is operative to transmit the column address to the read & write circuit 130.

To these ends, the address decoder 120 may therefore include a row decoder, a column decoder and an address buffer storing an address ADDR.

The read & write circuit 130 is coupled to the memory cell array 110 through the bit lines BL. The read & write circuit 130 also operates under the control of the control logic 140. More specifically, as mentioned above, the read & write circuit 130 receives the decoded column address from the address decoder 120, and selects the appropriate bit line BL using the decoded column address.

When the memory device 1000 is performing a programming operation, the read & write circuit 130 receives data from the input/output buffer 150 and programs the received data in selected ones of the memory cells of the memory cell array 110. When the memory device 1000 is performing a read operation, the read & write circuit 130 reads data from a storage area of the memory cell array 110, corresponding to the decoded column address, and transmits the read data to the input/output buffer 150. The read & write circuit 130 may also read data from a first storage area of the memory cell array 110 and write the read data in a second storage area of the memory cell array 110. That is, the read & write circuit 130 may also be configured to perform a copy-back operation.

To these ends, the read & write circuit 130 may include such components as a page buffer (or page register) and a column select circuit. The read & write circuit 130 may also include a sense amplifier, a write driver, and a column select circuit.

As is clear from the description above, the control logic 140 is coupled to the address decoder 120, the read & write circuit 130 and the input/output buffer 150. The control logic 140 is configured to control the overall operation of the nonvolatile memory 100. In this respect, the control logic 140 operates in response to a control signal CTRL transmitted from the outside, e.g., from the controller 200.

As is also clear from the description above, the input/output buffer 150 is coupled to the address decoder 120, the control logic 140 and the read & write circuit 130. The input/output buffer 150 receives a control signal CTRL and an address ADDR and transmits the control signal CTRL and the address ADDR to the control logic 140 and the address decoder 120 respectively.

The input/output buffer 150 facilitates an exchange of data between the nonvolatile memory 100 and the outside. When the memory device 1000 is performing a programming operation, the input/output buffer 150 transmits the received data from the outside to the read & write circuit 130. Conversely, when the memory device 1000 is performing a read operation, the input/output buffer 150 transmits data received from the read & write circuit 130 to the outside.

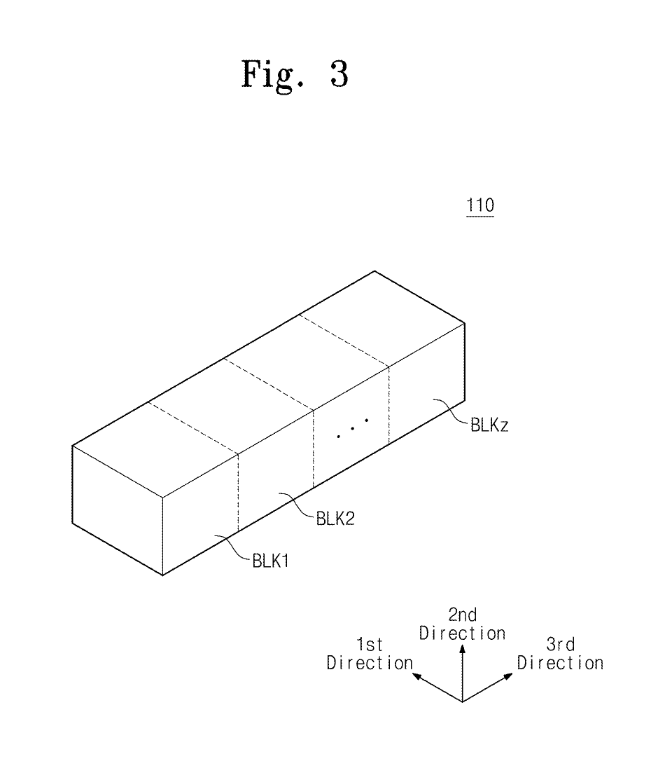

The memory cell array 110 of the nonvolatile memory 100 will now be described in more detail with reference to FIGS. 3-7.

In general, as mentioned above, the memory cell array 110 includes a plurality of memory blocks BLK1˜BLKz. Each of the memory blocks BLK1˜BLKz has a three-dimensional (or vertical) structure. Thus, each memory block BLK includes structures extending along first, second and third directions. More specifically, each memory block BLK includes a plurality of cell strings each extending along the second direction. The cell strings are arrayed (spaced from one another in rows and columns) in the first and third directions. Furthermore, each memory block is connected to a plurality of bit lines BL, a plurality of string select lines SSL, a ground select line GSL and a plurality of word lines WL.

More specifically, and with reference to FIGS. 3˜5, the memory cell array 110 includes at least a region of a substrate 111. The region of the substrate 111 may be a well of a first conductivity type. For example, the substrate 111 may have a P-well formed by implanting a Group III element such as boron (B) into the body of the substrate. Alternatively, the substrate 111 may have an N-well and a pocket P-well provided in the N-well. That is, in this example, the substrate will be assumed to have a p-type conductivity. However, the inventive concept may also be embodied as a memory cell array whose substrate has an n-type conductivity.

The substrate 111 also has a plurality of doped areas, e.g., first, second and third doped areas 311, 312 and 313, elongated in the first direction. The doped areas 311, 312 and 313 are spaced apart from one another by regular intervals in the third direction. The first, second and third doped areas 311, 312 and 313 are of a (second) conductivity type different from that of the substrate 111. Thus, in this example, the first, second and third doped areas 311, 312 and 313 have an n-type conductivity.

Each memory block has a plurality of stacks of insulating layers 112 and 112a disposed on the substrate 111. Each of the insulating layers 112 and 112a is elongated in the first direction. In this example, the insulating layers 112 and 112a are each a layer of silicon oxide layer. In any case, each stack of the insulating layers 112 and 112a is located between adjacent ones of a respective pair of the first, second and third doped areas 311, 312 and 313. Also, the insulating layers 112 and 112a of each stack are spaced from one another along the second direction (perpendicular to the substrate). Furthermore, respective ones of the insulating layers (designated by reference numeral 112a) of each stack contact the substrate 111, and the insulating layer 112a contacting the substrate 111 may be thinner than the other insulating layers 112 in the stack.

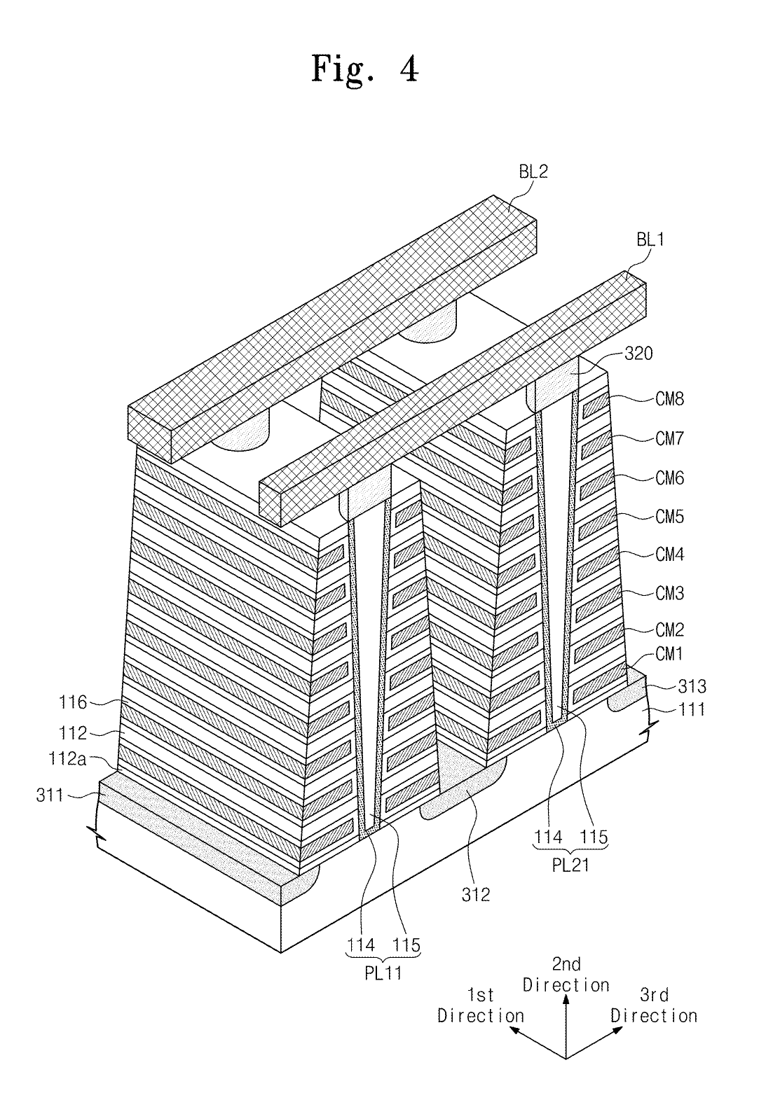

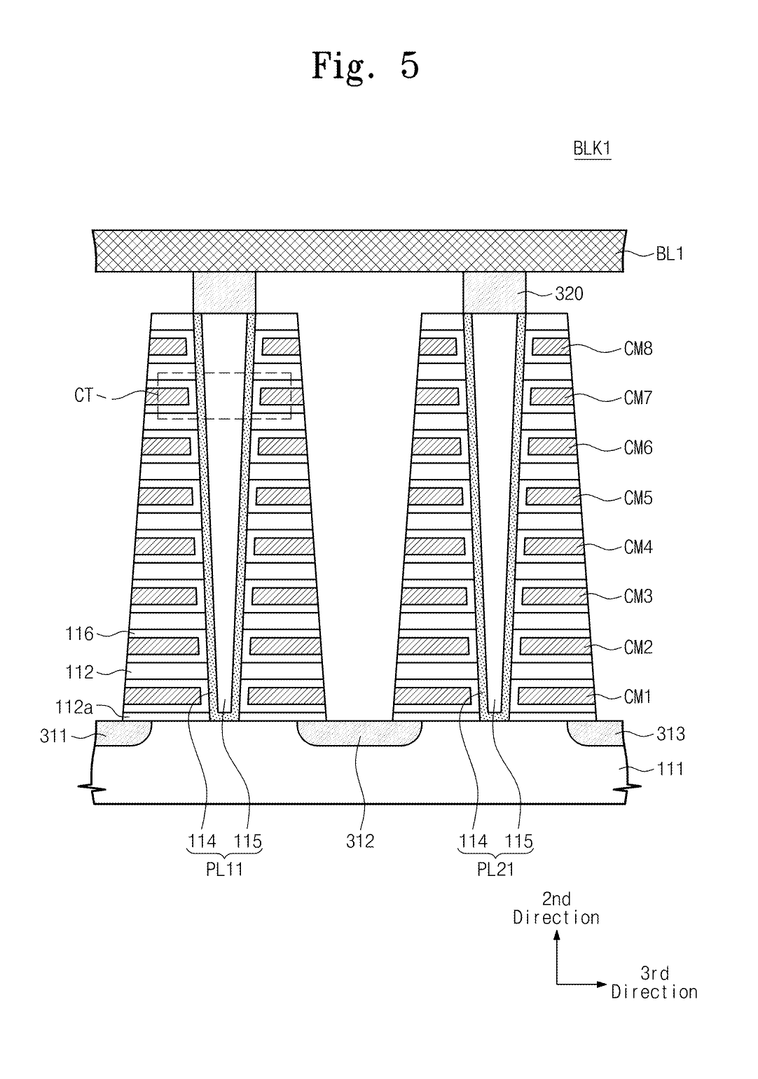

The memory block also has a plurality of rows (or sets) of pillars extending upright on the substrate 111. In FIGS. 4 and 5, only one pillar PL11 and PL21 of each row can be seen as each of the rows of pillars is located between adjacent ones of a respective pair of the doped areas 311, 312 and 313 and the pillars of each row thereof are spaced from each other in the first direction. Furthermore, the pillars of each row thereof extend through a respective stack of the insulating layers 112, 112a in the second direction. In this respect, the width of each of the pillars PL11, PL12 . . . decreases in the second direction towards the substrate 111. Also, the pillars may each contact the substrate 111.

In addition, each of the pillars PL11, PL12 . . . has a multi-layered structure. In this example, the pillars each have a channel layer 114 and a core 115 surrounded by the channel layer 114. The channel layer 114 is of semiconductor material of the same conductivity type as the substrate 111. Thus, in this example, the channel layers 114 have a p-type conductivity. For example, the channel layers 114 may be of silicon provided with a p-type conductivity. Alternatively, the channel layers 114 may be of intrinsic semiconductor material of no specific conductivity type.

The cores 115 are insulating. For example, the cores 115 may be of insulating material such as silicon oxide. Alternatively, the cores 115 may be constituted by pockets of air.

Each memory block BLKₙ also has information storage layers 116 extending along the outer surfaces of the insulating layers 112, 112a and the pillars. Like the insulating layers 112, 112a, the information storage layers 116 are located on the substrate 111 between adjacent ones of the first, second and third doped areas 311, 312 and 313.

Each memory block also has conductive layers CM1˜CM8. The conductive layers CM1˜CM8 may be of a metallic conductive material. Alternatively, the conductive layers CM1˜CM8 may be of a nonmetallic conductive material such as doped polysilicon. The conductive layers CM1˜CM8 are interposed between sections of the information storage layers 116 which extend on upper and lower surfaces of the insulating layer 112, 112a. Thus, like the insulating layers 112, 112a and the information storage layers 116, the CM1˜CM8 are located between adjacent ones of the first, second and third doped areas 311, 312 and 313.

Drains 320 are disposed on the pillars PL11, PL12 . . . , respectively. The drains 320 are of semiconductor material (e.g., silicon) of the second conductivity type, i.e., of a conductivity type different than that of the substrate 111. Thus, in this example, the drains 320 have an n-type conductivity.

Bit lines BL1 and BL2 extending longitudinally in the third direction and spaced from each other in the first direction are disposed on the drains 320 and are electrically connected to the drains 320. In this respect, the drains 320 and the bit lines BL1 and BL2 may be connected to one another through contact plugs. The bit lines BL1 and BL2 may be of metallic conductive material or nonmetallic conductive materials such as doped polysilicon.

As is clear from the description above, the pillars of each memory block are arranged in rows and columns with, for example, the pillars PL11, PL22 constituting one of the columns of pillars of the memory block BLK1. A first row of the pillars including pillar PL11 are connected by the conductive layers CM1˜CM8 and the information storage layers 116 located between the first doped area 311 and the second doping area 312. A second row of pillars including PL21 are connected by the conductive layers CM1˜CM8 and the information storage layers 116 located between the second doped area 312 and the third doped area 313. That is, the rows of pillars are oriented in or run parallel to the first direction.

The columns of the pillars are oriented along the bit lines BL1 and BL2, respectively. That is, a first column of pillars PL11 and PL21 is electrically connected to the first bit line BL1 through drains 320. A second column of pillars is electrically connected to the second bit line BL2 through drains 320. That is, the columns of pillars are oriented in (i.e., run parallel to) the third direction.

Each of the pillars together with the adjacent information storage layers 116 and the conductive layers CM1˜CM8 adjacent thereto constitute a respective cell string CS. That is, the pillars PL11, PL12 . . . form a plurality of cell strings together with the information storage layers 116 and the plurality of conductive layers CM1˜CM8. Each of the cell strings includes a plurality of cell transistors stacked on the substrate 111.

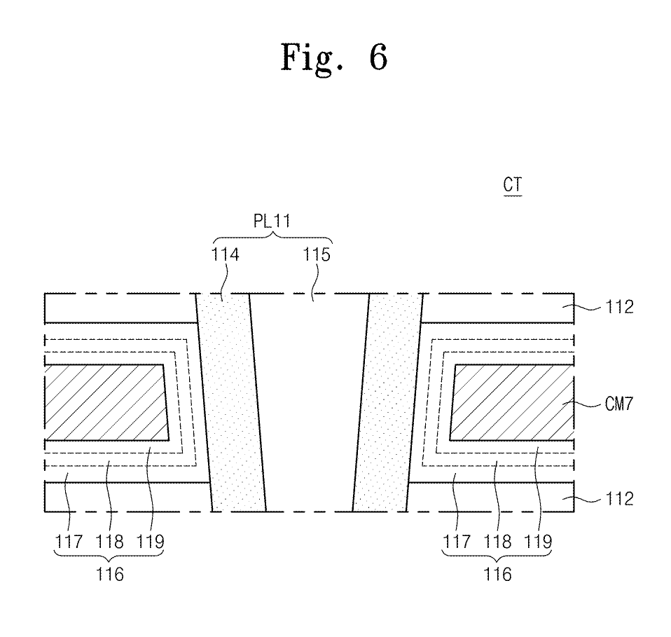

One of the cell transistors CT will be described in detail with reference to FIGS. 5 and 6.

This particular cell transistor CT comprises a seventh conductive layer CM7 (the seventh conductive layer from the substrate 111), a part of the pillar PL11 adjacent to the seventh conductive layer CM7, and that part of an information storage layer 116 interposed between the seventh conductive layer CM7 and the pillar PL11 and which extends between top and bottom surfaces of the seventh conductive layer CM7. The information storage layer 116 itself includes first, second and third sub insulating layers 117, 118 and 119.

As mentioned above, the channel layer 114 is of the same conductivity type as the substrate 111. The channel layer 114 functions as the body of the cell transistor. Thus, the channel layer 114 of the pillar PL11 is a vertical body, and the channel formed in the channel layer 114 is a vertical channel.

The seventh conductive layer CM7 functions as a gate (or control gate).

The first sub insulating layer 117 adjacent to the pillar PL11 serves as a tunneling insulating layer. To this end, the first sub insulating layer 117 adjacent to the pillar PL11 may be a thermal oxide layer. For example, the first sub insulating layer 117 is a silicon oxide layer.

The second sub insulating layer 118 serves as a charge storage or charge capturing layer. To this end, the second sub insulating layer 118 may be a nitride layer (e.g., a silicon nitride layer) or a metallic oxide layer (e.g., an aluminum oxide layer or a hafnium oxide layer).

The third sub insulating layer 119 adjacent to the seventh conductive material CM7 serves as a blocking insulating layer. To this end, the third sub insulating layer 119 may be a high-k dielectric layer having a dielectric constant higher than the first and second sub insulating materials 117 and 118 (e.g., an aluminum oxide layer or a hafnium oxide layer) or the third sub insulating layer 119 may be a silicon oxide layer. Also, the third sub insulating layer 119 may consist of a single layer of material or may be multi-layered.

In an example of this embodiment, the first, second and third sub insulating layers 117, 118 and 119 may be constituted by an oxy-nitride-oxide (ONO) layer.

The purposes of the cell transistors may depend on the level that they occupy in the memory cell array 110. For instance, at least one cell transistor disposed at an upper portion of the memory cell array 110 may be used as a string select transistor SST. At least one cell transistor disposed at a lower portion of the memory cell array may be used as a ground select transistor GST. The rest of the cell transistors may be used as memory cells.

Referring back to FIG. 5, the conductive layers CM1˜CM8 are elongated in the first direction and are electrically connect to the pillars PL11 . . . , PL21 . . . . That is, in the memory block BLK1, each stack of conductive layers CM1˜CM8 disposed on the substrate 111 at a location between adjacent ones of a pair of the doped areas 311, 312, 313 constitutes conductive lines connecting the cell transistors of the same row to one another.

Each conductive layer CM1˜CM8 may be used as a string select line SSL, a ground select line GSL or a word line WL depending on the level that the conductive layer occupies in the memory call array 110.

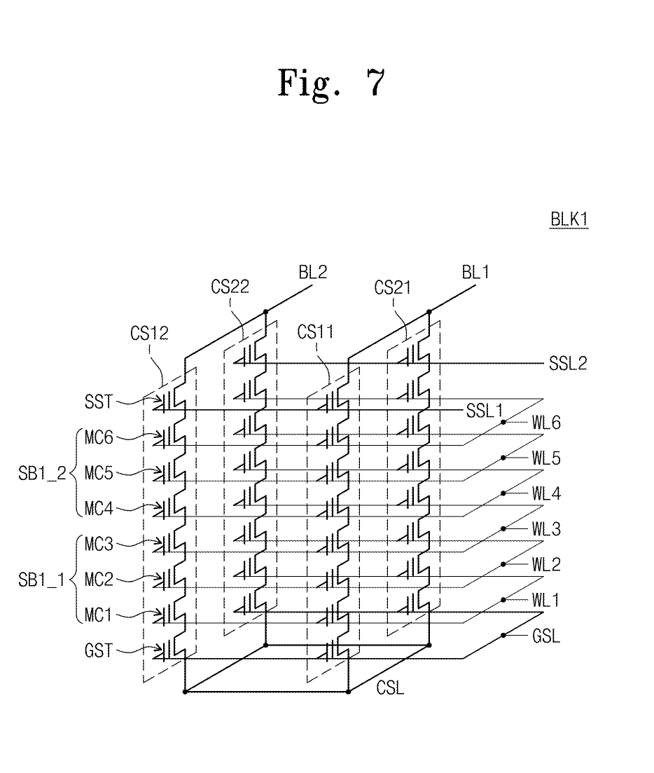

FIG. 7 illustrates an equivalent circuit of a memory block (in this case of memory block BLK1). Referring to FIGS. 4 through 7, cell strings CS11 and CS21 are provided between the first bit line BL1 and a common source line CSL. Cell strings CS12 and CS22 are provided between the second bit line BL2 and the common source line CSL. The cell strings CS11, CS21, CS12 and CS22 correspond to the pillars PL11, PL21, . . . of the memory block BLK1, respectively, along with portions of the conductive layers CM1˜CM8 and the information storage layers 116. For example, the pillar PL11 constitutes the cell string CS11 of the first row and first column together with respective portions of the conductive layers CM1˜CM8 and information storage layers 116. The pillar PL21 constitutes the cell string CS21 of the second row and first column together with respective portions of the conductive layers CM1˜CM8 and the information storage layers 116.

In this example, the cell transistors CT occupying the first level of the memory cell array 110 operate as ground select transistors GST in the cell strings CS11, CS21, CS12 and CS22. The first conductive layers CM1 are connected to each other to form the ground select line GSL. The cell transistors occupying the eighth level of the memory cell array 110 operate as string select transistors SST in the cell strings CS11, CS21, CS12 and CS22. The string select transistors SST are connected to first and second string select lines SSL1 and SSL2.

Cell transistors occupying the second level of the memory cell array 110 operate as first memory cells MC1. Cell transistors occupying the third level of the memory cell array 110 operate as second memory cells MC2. Cell transistors occupying the fourth level of the memory cell array 110 operate as third memory cells MC3. Cell transistors occupying the fifth level of the memory cell array 110 operate as fourth memory cells MC4. Cell transistors occupying the sixth level in the memory cell array 110 operate as fifth memory cells MC5.

Each sub memory block SB1_1, SB1_2 of the memory block BLK1 includes a plurality of memory cells. In this example, the first sub memory block SB1_1 includes first through third memory cells MC1˜MC3. The second sub memory block SB1_2 includes fourth through sixth memory cells MC4˜MC6.

Furthermore, the cell strings of the same row share a respective string select line. The first conductive layers CM1 are connected to one another to form a ground select line GSL. The second conductive layers CM2 are connected to one another to form a first word line WL1. The third conductive layers CM3 are connected to one another to form a second word line WL2. The fourth conductive layers CM4 are connected to one another to form a third word line WL3. The fifth conductive layers CM5 are connected to one another to form a fourth word line WL4. The sixth conductive layers CM6 are connected to one another to form a fifth word line WL5. The seventh conductive layers CM7 are connected to one another to form a sixth word line WL6. The first and second string select lines SSL1 and SSL2 correspond to the eighth conductive layers CM8.

The common source line CSL is connected in common to the cell strings CS11, CS21, CS12 and CS22. For example, the first, second and third doping areas 311, 312 and 313 are connected to one another to form the common source line CSL.

Memory cells occupying the same level in the memory array are connected in common to a respective word line. Thus, when a specific word line is selected, those memory cells occupying a respective level in the memory cell array are selected.

Thus, rows of cell strings are connected to string select lines, respectively. Accordingly, in this example, when one of the first and second string lines SSL1 and SSL2 is selected and the other is not (i.e., is unselected), the cell strings (CS11 and CS12 or CS21 and CS22) of the unselected row are electrically isolated from the bit lines BL1 and BL2 whereas the cell strings (CS21 and CS22 or CS11 and CS12) of the selected row are electrically connected to the bit lines BL1 and BL2. That is, by selecting between the first and second string select lines SSL1 and SSL2, rows of the cell strings CS11, CS21, CS12 and CS22 can be selected. On the other hand, by selecting between the bit lines BL1 and BL2, a cell string in the column intersecting the selected row can be selected.

As was mentioned above, a program operation and a read operation are performed by a page unit.

First, the program operation will be described in more detail. An address ADDR received from outside the memory block corresponds to a specific page. More specifically, cell strings connected to a respective string select line are selected, a pass voltage is applied to each of unselected word lines (e.g., WL1˜WL4, WL6) and a program voltage is applied to a selected word line (e.g., WL5), based on the ADDR. The threshold voltages of the memory cells of the page connected to the selected word line are changed due to the program voltage applied to the selected word line. Accordingly, data stored in each of those memory cells is changed. That is, memory cells connected to the same word line of the page are programmed at once.

Next, a read operation will be described in more detail. In this operation as well, an address ADDR received from outside the memory block corresponds to a specific page. The cell strings connected to a respective string select line are selected, a read voltage is applied to a selected word line (e.g., WL5) and an unselect read voltage higher than the read voltage is applied to each of unselected word lines (e.g., WL1˜WL4, WL6). In this case, the threshold voltages of memory cells of the page connected to the unselected word lines are changed. In this way, data of memory cells of the page connected to the same word line are read at once.

As was also mentioned above, an erasure operation is performed sub memory block unit by sub memory block unit. An example of erasing data will now be described in more detail.

In this example, the data is to be erased from sub memory block SB1_2. A power supply voltage is applied to word lines connected to sub memory block SB1_2 to be erased and a high erasure-inhibit voltage is applied to word lines connected to an erasure-inhibit sub memory block SB1_1. A high erasure voltage is applied to the substrate 111. Recall that the memory cells of each cell string are connected to a respective pillar. Therefore, the threshold voltages of memory cells of the erasure-inhibit sub memory blocks are changed due to the erasure voltage transferred from the substrate 111 through the pillar and an erasure-inhibit voltage applied through word lines. Thus, data of memory cells MC4˜MC6 of the second sub memory block SB2_1 are erased at once. Data of memory cells MC1˜MC3 of the first sub memory block SB1_1 can be erased at once in a similar way.

The management data and the main data may be stored in the first and second sub memory blocks SB1_1 and SB1_2, respectively, because the first and second sub memory blocks SB1_1 and SB1_2 are erasable independently. Again, as an example of the inventive concept only, the management data is stored in the first sub memory block SB1_1 and the main data is stored in the second sub memory block SB1_2. Thus, the second sub memory block SB1_2 storing the main data may be more frequently accessed than the first sub memory block SB1_1 configured with the management data. This means that program, read and erasure operations are more frequently performed on the second sub memory block SB1_2 than on the first sub memory block SB1_1.

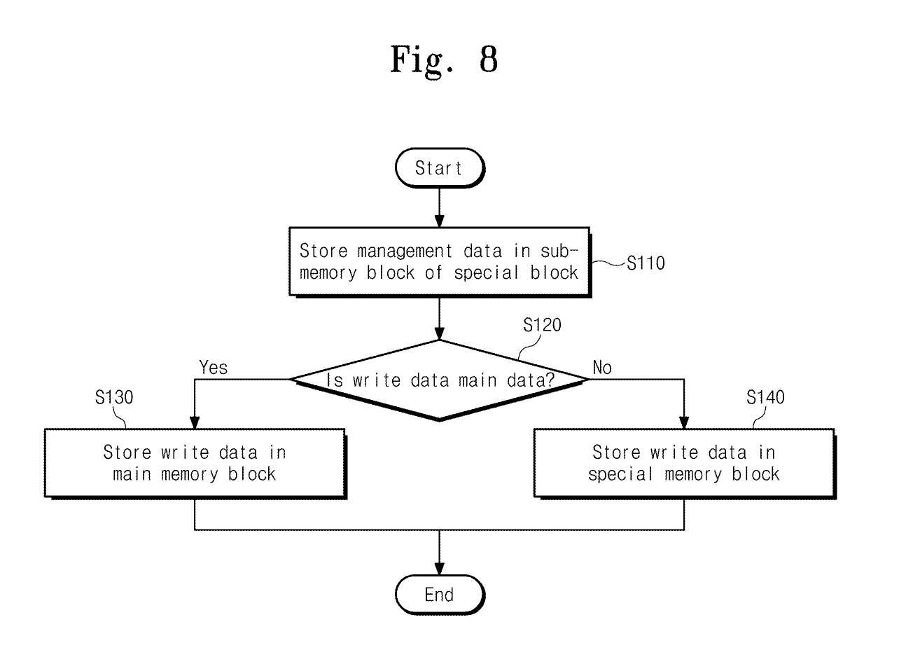

A data storage method of the memory device 1000 will now be described with reference to FIG. 8.

In S110, management data is stored in at least one sub memory block of a special memory block. The management data may be stored during a test performed after the nonvolatile memory 100 has been fabricated or may be performed after the test by the controller 200 while accessing the nonvolatile memory 100. In any case, the management data is pre-programmed data that is not changed once the nonvolatile memory 100 begins performing its memory-related operations, including read, write and erase operations.

In S120, a type of data to be written (hereinafter write data) in the nonvolatile memory 100 is distinguished. For example, the write data is determined to be main data when the write data is received based on a write request from the host. On the other hand, the write data is determined to be management data when the write data is not data received from the host.

In the case in which the write data is determined to be main data, the write data is stored in the main memory block (S130). In the less frequent case in which the write data is determined to be management date, the write data is stored in the special memory block (S140).

Thus, the management data stored in the special memory block is not damaged due to the frequent operations of erasing, programming and reading the main data. Consequently, the management data stored in the special memory block remains highly reliable throughout the operation of the memory device.

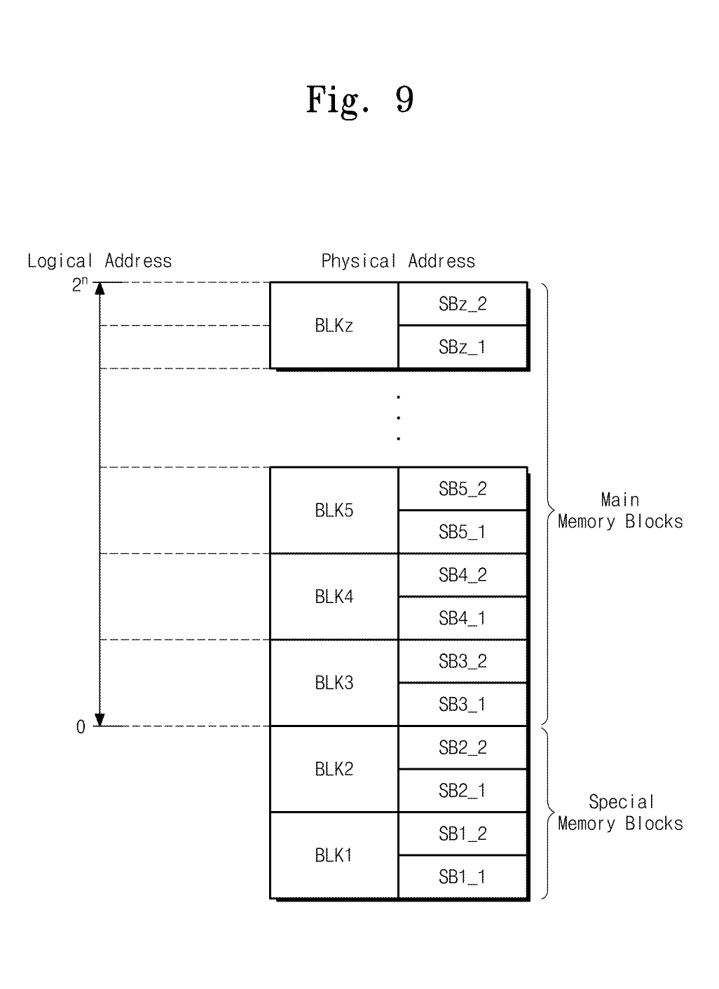

An example of mapping between logical addresses provided by a host and the memory blocks BLK1˜BLKz of the memory cell array 110 will now be described with reference to FIG. 9.

In the example shown in FIG. 9, the first and second memory blocks BLK1 and BLK2 are special memory blocks and the third through zth memory blocks BLK3˜BLKz are main memory blocks. According to an aspect of the inventive concept, the controller 200 is configured such that it does not map a logical address provided by the host to a physical address of any of the special memory blocks, i.e., the first and second memory blocks BLK1 and BLK2 in this example. Rather, the controller 200 only maps logical addresses received from the host to physical addresses of the third through zth memory blocks BLK3˜BLKz (the main memory blocks).

That is, in the example show in FIG. 9, a logical address received from the host is mapped to a physical address of the third through zth memory blocks BLK3˜BLKz. However, the memory blocks BLK1 and BLK2 may not be dedicated as the special memory blocks. At least one of the other memory blocks BLK3˜BLKz may be changed to a special memory block. In this case, data of the memory blocks BLK1 and BLK2 may migrate to at least one of the other memory blocks BLK3˜BLKz and may be deleted. That is, the memory blocks BLK1 and BLK2 may be refreshed or reclaimed.

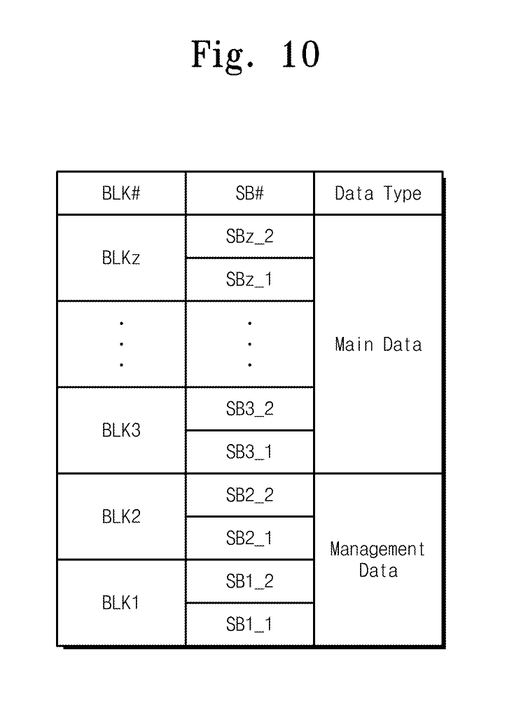

FIG. 10 is a table showing the types of data stored in first through zth memory blocks BLK1˜BLKz, according to the example of the mapping relation shown in and described with reference to FIG. 9. Referring to FIG. 10, the main data received from the host is stored in the memory blocks BLK3˜BLKz. The management data is stored in the memory blocks BLK1 and BLK2. That is, the main data and the management data may be stored in the memory blocks, separately.

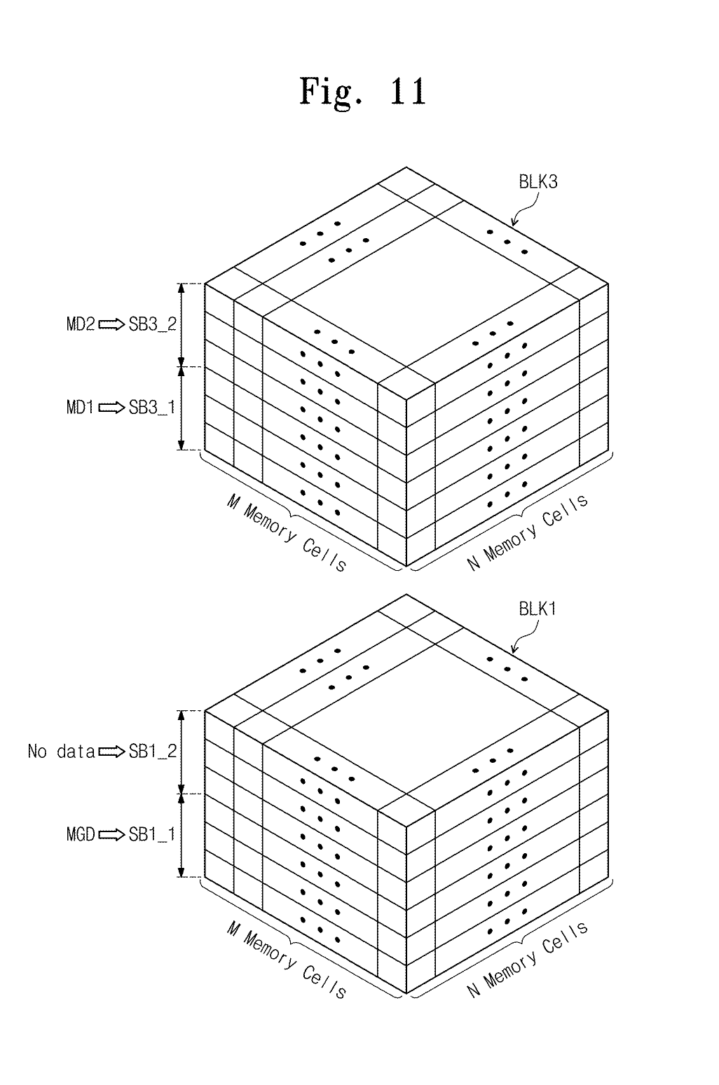

FIGS. 11 through 14 show examples of an embodiment of a method by which management data (MGD) or management and meta data (MGD1, MGD2), and main data (MD1, MD2) are stored according to the inventive concept. In FIGS. 11 through 14, only memory cells of select ones of the memory blocks of the memory cell array 110 (FIGS. 1-3) are illustrated. Each memory block includes m number of memory cells arranged in the first (row) direction, n number of memory cells arranged in the second (column) direction, and six memory cells (corresponding to MC1-MC6 in FIG. 7) in each of the n×m cell strings (CS).

In the example shown in FIG. 11, the first and third memory blocks BLK1 and BLK3 include first and second sub memory blocks (SB1-1 and SB1_2, SB3_1 and SB3_2), respectively.

First, assume that the management data MGD is stored in the first sub memory block SB1_1 of the first memory block BLK1. Assume that first and second main data (MD1, MD2) are sequentially received from the host. In this case, the first and second main data (MD1, MD2) are not stored in the second sub memory block SB1_2 of the first memory block BLK1. On the contrary, the first and second main data (MD1, MD2) are stored in the third memory block BLK3. In the specific example illustrated in FIG. 11, the first and second main data (MD1, MD2) are stored in the first and second sub memory blocks SB3_1 and SB3_2 of the third memory block BLK3, respectively. The second sub memory block SB1_2 of the first memory block BLK1 remains a vacant block in which no data is stored.

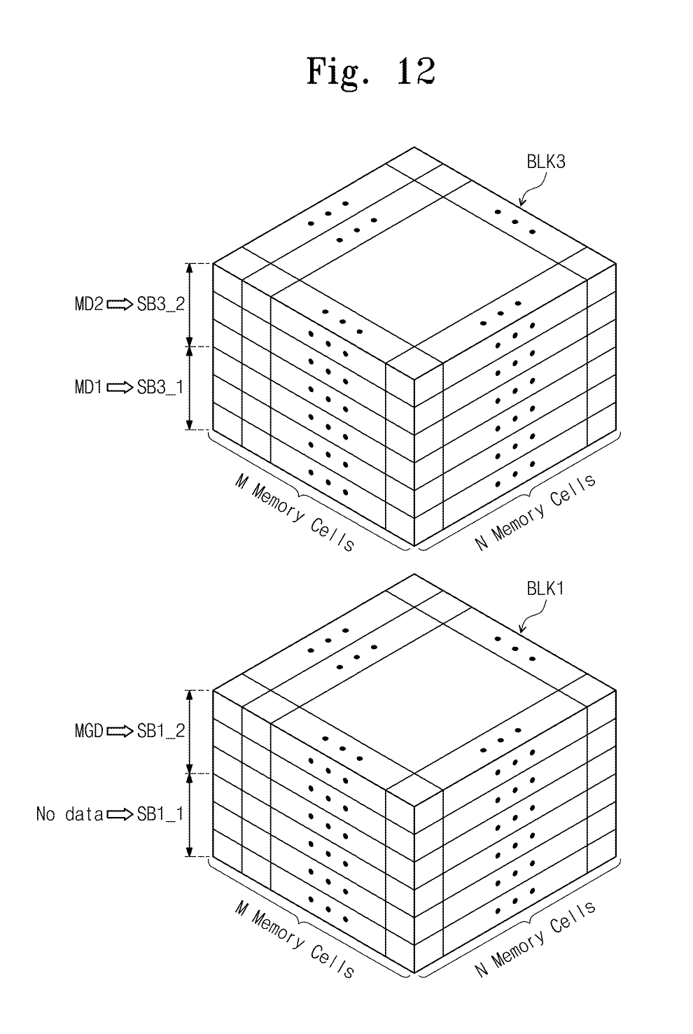

In the example shown in FIG. 12, the management data MGD is stored in second sub memory block SB1_2 of the first memory block BLK1. In this case, the first and second main data (MD1, MD2) are not stored in the first sub memory block SB1_1 of the first memory block BLK1. Rather, the controller 200 again stores the first and second main data (MD1, MD2) in the third memory block BLK3. The first sub memory block SB1_1 of the first memory block BLK1 remains a vacant block in which no data is stored.

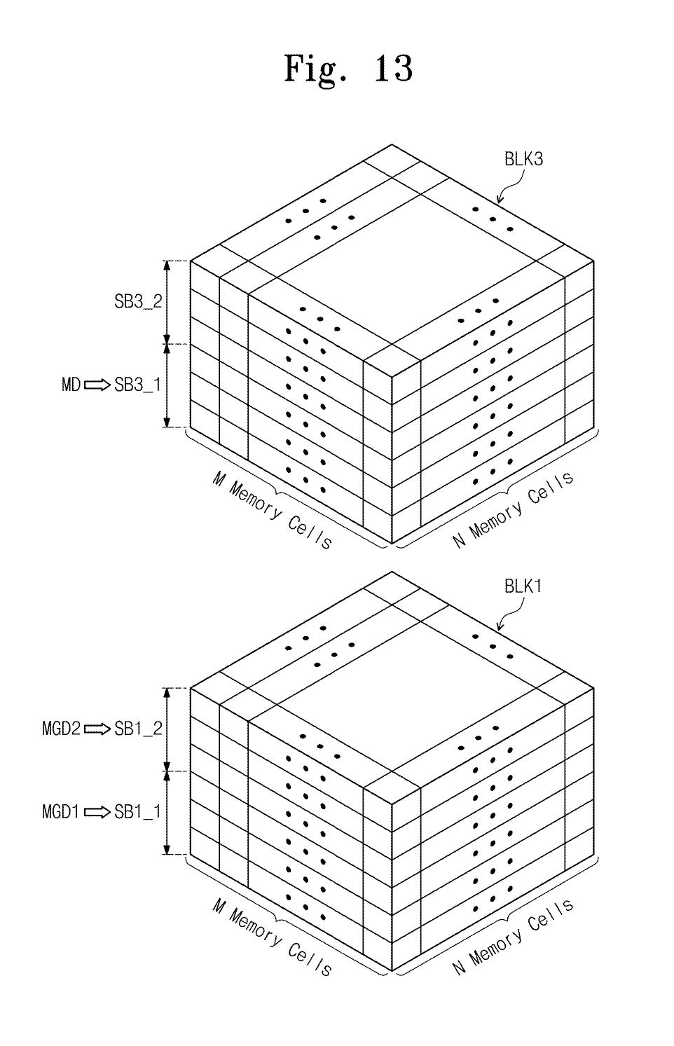

In the example shown in FIG. 13, first management data MGD1 is stored in the first sub memory block SB1_1 of the first memory block BLK1 in advance. After that, first main data MD1 is stored in the first sub memory block SB3_1 of the third memory block BLK3. If second management data MGD2 is generated by the controller 200, the second management data MGD2 is stored in the first memory block BLK1. That is, the controller 200 stores the second management data MGD2 in the second sub memory block SB1_2 of the first memory block BLK1, not in the second sub memory block SB3_2 of the third memory block BLK3.

In this example, the first management data MGD1 stored in the first sub memory block SB1_1 of the first memory block BLK1 is data that will remain unchanged after it is programmed during a testing phase after the nonvolatile memory 100 has been processed. For example, as was described above, the first management data MGD1 may be data establishing an operating environment of the memory device 1000 such as data that creates algorithms for operating the nonvolatile memory 100, data for effecting an initial operation of the nonvolatile memory 100, E-Fuse data, or data that creates algorithms tied to the operation of the controller 200. The second management data MGD2 in this example is meta data. When the second management data MGD2 is deleted the first management data MGD1 may also be deleted because an erasure operation of the nonvolatile memory 100 can be performed by units in the memory blocks.

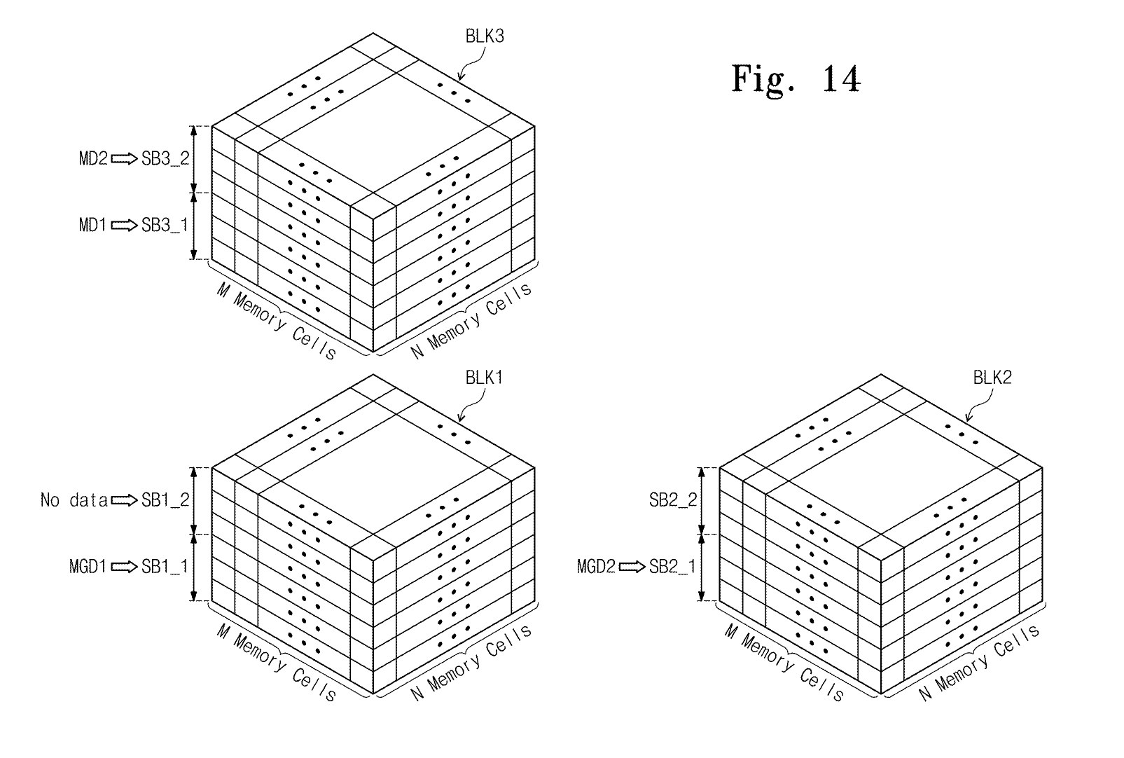

In the example shown in FIG. 14, the first management data MGD1 is stored in the first sub memory block SB1_1 or SB2-2 of one of the first and second memory blocks BLK1 and BLK 2. When the first and second main data (MD1, MD2) are sequentially received from the host, the first and second main data (MD1, MD2) are stored in the third memory block BLK3. If the second management data MGD2 is generated, the controller 200 stores the second management data MGD2 in the first sub memory block of the other of the memory blocks BLK1 and BLK2, i.e., in the special memory block in which the first management data MGD1 is not stored. That is, the controller 200 selectively stores the first and second management data MGD1 and MGD2 in respective ones of the first memory block BLK1 and the second memory block BLK2. The first management data MGD1 stored in the first sub memory block SB1_1 of the first memory block BLK1 is data that will remain unchanged after it is programmed during a testing phase after the nonvolatile memory 100 has been processed. The second management data MGD2 is meta data generated while using the nonvolatile memory 100 after the testing phase.

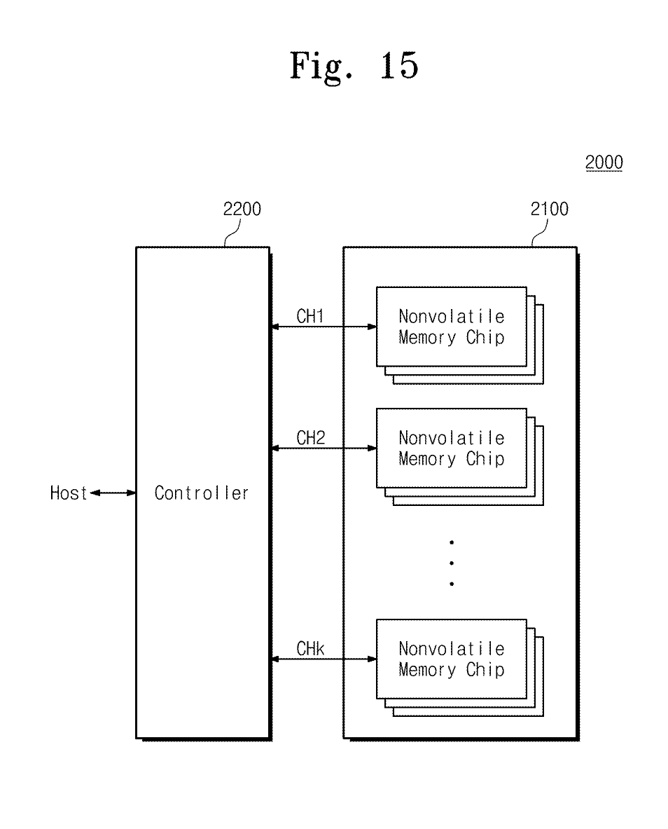

Another example of the memory device generally shown in FIG. 1 is illustrated in FIG. 15. Referring to FIG. 15, the memory device 2000 includes a nonvolatile memory 2100 and a controller 2200 coupled to one another through first through kth channels.

The nonvolatile memory 2100 includes a plurality of groups of nonvolatile memory chips. Each nonvolatile memory chip is configured and operates the same as the nonvolatile memory 100 described with reference to FIG. 1. In the illustrated example, each of the groups of nonvolatile memory chips communicates with the controller 2200 through a respective one of the channels CH1˜CHk, i.e., the groups of nonvolatile memory chips communicate with the controller 2200 through common channels, respectively. Alternatively, the nonvolatile memory chips may be respectively connected to the controller 2200 by channels each dedicated to only one chip.

The controller 2200 includes constituent elements well known per se such as a random access memory (RAM), a processing unit, a host interface and a memory interface. The RAM may be used as at least one of an operation memory of a processing unit, a cache memory between the nonvolatile memory 2100 and a host and a buffer memory between the nonvolatile memory 2100 and the host. An address mapping table is stored in the RAM and managed by the controller 2200. The processing unit controls the entire operation of the memory device 2000.

The host interface contains the protocol(s) by which data can be exchanged between the host and the controller 2200, e.g., contains at least one of various interface protocols such as a universal serial bus (USB) protocol, a multimedia card (MMC) protocol, a peripheral component interconnection (PCI) protocol, a PCI-express protocol, an advanced technology attachment (ATA) protocol, a serial-ATA protocol, a parallel-ATA protocol, a small computer small interface (SCSI) protocol, an enhanced small disk interface (ESDI) protocol, and an integrated drive electronics (IDE) protocol. The memory interface includes a NAND interface or a NOR interface.

The nonvolatile memory 2100 and the controller 2200 may be integrated in one semiconductor device.

As one example, the nonvolatile memory 2100 and the controller 2200 may form a memory card such as a PC card, a compact flash (CF) card, a smart media (SM) card, a memory stick, a multimedia card (MMC, RS-MMC, MMCmicro), an SD card (SD, miniSD, microSD, SDHC), or a universal flash memory device (UFS).

As another example, the nonvolatile memory 2100 and the controller 2200 may form a semiconductor data storage device namely, a solid state drive (SSD). In this case, the SSD facilitates a higher operating speed of the host connected to the memory device 2000.

Furthermore, the memory device 2000 may be employed by various types of electronic devices such as by any type of computer including an ultra mobile PC (UMPC), a workstation, a net-book, a personal digital assistance (PDA), or a web tablet, by any type of wireless phone such as a cell phone or a smart phone, and by an e-book, a portable multimedia player (PMP), a portable game machine, a navigation device, a black box, a digital camera, a three-dimensional television, a digital audio recorder, a digital audio player, a digital picture recorder, a digital picture player, a digital video recorder, and a digital video player. Essentially the memory device 2000 may be employed by any type of electronic device that can transmit/receive information in a wireless environment, and/or that constitutes a home, office or telematics network, and/or an RFID device.

Also, the nonvolatile memory 2100 and the memory device 2000 may be packaged in various ways, e.g., as part of a PoP (package on package), ball grid array (BGA) package, chip scale package (CSP), plastic leaded chip carrier (PLCC), plastic dual in-line package (PDIP), die in waffle pack, die in wafer form, chip on board (COB) package, ceramic dual in-line package (CERDIP), plastic metric quad flat pack (MQFP), thin quad flat pack (TQFP), small outline (SOIC) package, shrink small outline package (SSOP), thin small outline package (TSOP), thin quad flatpack (TQFP), system in package (SIP), multi chip package (MCP), wafer-level fabricated package (WFP) and wafer-level processed stack package (WSP).

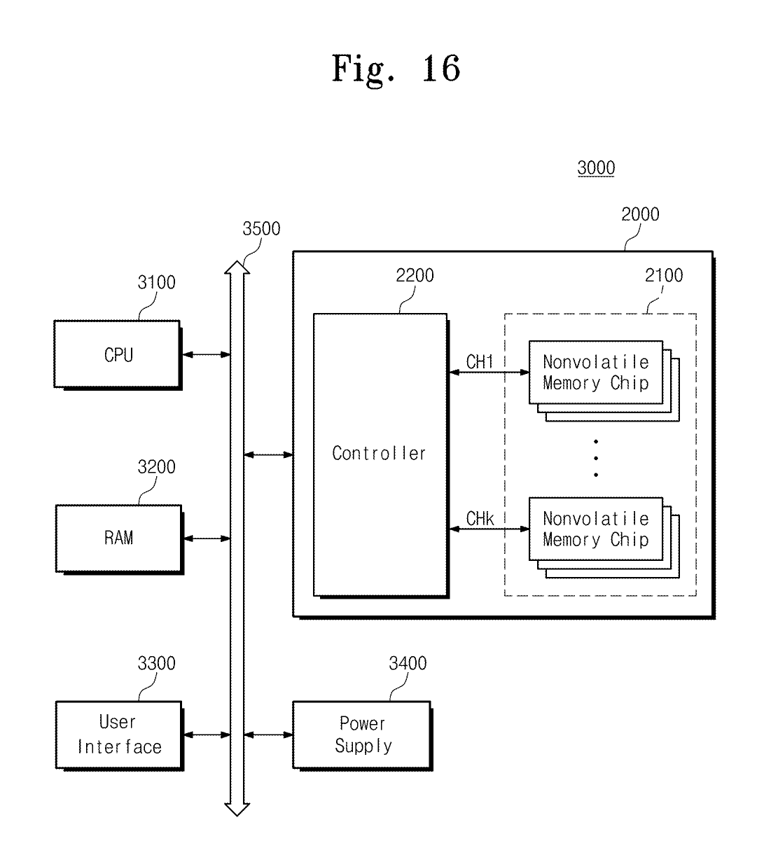

FIG. 16 illustrates a computing system 3000 including a memory device similar to the memory device 2000 described shown in and described with reference to FIG. 15, according to the inventive concept. Referring to FIG. 16, the computing system 3000 includes a central processing unit (CPU) 3100, a random access memory (RAM) 3200, a user interface 3300, a power supply 3400 and a memory device 2000.

The memory device 2000 is coupled to the central processing unit (CPU) 3100, the random access memory (RAM) 3200, the user interface 3300 and the power supply 3400 through a system bus 3500. Data provided by the user interface 3300 or processed by the central processing unit (CPU) 3100 is stored in the memory device 2000.

In the example of the computing system 3000 shown in FIG. 16, the nonvolatile memory 2100 is coupled to the system bus 3500 through the controller 2200. However, the nonvolatile memory 2100 may be directly coupled to the system bus 3500. In any case, the controller 2200 is operated under the command of the central processing unit (CPU) 3100. The RAM 3200 illustrated in FIG. 16 may be used in place of the RAM of the controller 2200 mentioned in connection with the memory device illustrated in FIG. 15.

Also, the computing system 3000 of FIG. 16 has been described as including a memory device similar to that of FIG. 15. Alternatively, the computing system 3000 may include a memory device similar to the memory device 1000 described with reference to FIG. 1 and/or FIG. 2.

According to an aspect of the inventive concept as described above, even if a sub memory block of a memory block containing management data is vacant when main data is received, the main data is stored in a different memory block. Thus, the management data will not be damaged due to the frequent renewal of the main data. Accordingly, a nonvolatile memory according to the inventive concept will remain highly reliable.

Finally, embodiments of the inventive concept and examples thereof have been described above in detail. The inventive concept may, however, be embodied in many different forms and should not be construed as being limited to the embodiments described above. Rather, these embodiments were described so that this disclosure is thorough and complete, and fully conveys the inventive concept to those skilled in the art. Thus, the true spirit and scope of the inventive concept is not limited by the embodiment and examples described above but by the following claims.

What is claimed is:

1. A nonvolatile memory comprising:
a plurality of memory blocks storing main data, management data, and meta data,
the memory blocks including at least one main memory block and at least one special memory block, each of the memory blocks comprising a plurality of sub memory blocks stacked on a substrate such that the sub-memory blocks of each of the main and special memory blocks are arrayed in a direction perpendicular to the substrate, and
wherein each of the sub memory blocks comprises an array of memory cells,
the memory cells of one of the sub memory blocks of the at least one special memory block are pre-programmed with the management data,
the memory cells of at least one of the sub memory blocks of the at least one main memory block are configured with the main data, and
the memory cells of one of the sub memory blocks of one of the memory blocks that contains no main data are configured with the meta data.

2. The nonvolatile memory of claim 1, wherein the management data is data programmed in a testing phase after processing.

3. The nonvolatile memory of claim 1, wherein the meta data is data generated after a testing phase after processing the nonvolatile memory.

4. The nonvolatile memory of claim 1, configured such that data stored in all of the memory cells constituting any respective one of the sub memory blocks can be erased at once, and such that data stored in the memory cells constituting any one of the sub memory blocks constituting each respective one of the memory blocks can be erased independently of the data stored in the memory cells constituting each other sub memory block constituting the respective memory block.

5. A memory device comprising:
a nonvolatile memory having at least one main memory block and a special memory block, each of the memory blocks including a plurality of sub memory blocks stacked in a direction perpendicular to a substrate; and
a controller operative to store main data received from outside the memory device in the nonvolatile memory, and
wherein the nonvolatile memory is configured such that data stored in any one of the sub memory blocks constituting each respective one of the memory blocks can be erased independently of the data stored in each other sub memory block constituting the respective memory block, and
such that only management data is stored in at least one of the sub memory blocks of the special memory block, and
the device is configured with a map that allows the controller to store any of the main data received from outside the memory device in the at least one main memory block but prevents the controller from storing any of the main data received from outside the memory device in the special memory block.

6. The memory device of claim 5, wherein the management data is data unchanged after it is programmed once in a testing phase after processing the nonvolatile memory.

7. The memory device of claim 6, wherein the controller is configured to generate meta data for managing the nonvolatile memory after the testing phase.

8. The memory device of claim 7, wherein the controller is configured to store the meta data in the special memory block.

9. The memory device of claim 7, wherein the controller is configured to store the meta data in one of the sub memory blocks constituting one of the main memory blocks.

10. The memory device of claim 7, wherein the controller is configured to store the meta data in one of the memory blocks that does not contain any of the management data or the main data.

11. The memory device of claim 5, wherein the management data is stored in at least one but not all of the sub memory blocks of the special memory block, and each other sub memory block constituting the special memory block and that does not contain the management data contains no data in the memory device.

12. The memory device of claim 11, wherein the sub memory blocks of the special memory block include a first sub memory block on the substrate, and a second sub memory block on the first sub memory block,
the management data is stored in the first sub memory block, and
the second sub memory block contains no data for the memory device and the controller is configured to prevent it from ever programming the second sub memory block with data.

13. The memory device of claim 11, wherein the sub memory blocks of the special memory block include a first sub memory block on the substrate, and a second sub memory block on the first sub memory block,
the management data is stored in the second sub memory block, and
the first sub memory block contains no data for the memory device and the controller is configured to prevent it from ever programming the first sub memory block with data.

14. The memory device of claim 5, wherein the controller translates logical addresses accompanying main data received from outside the memory device into physical addresses of only respective ones of the sub blocks that do not contain the management data.

15. A device that includes a nonvolatile memory, and wherein the device comprises:
a memory cell array constituting the nonvolatile memory; and an address map,
the memory cell array having main memory blocks and at least one special memory block,
each of the main and special memory blocks including a plurality of sub memory blocks stacked on a substrate in a direction perpendicular to the substrate, and each of the sub memory blocks has a plurality of memory cells, and
the memory cells of at least one of the sub memory blocks of the at least one special memory block being pre-programmed with management data that controls management of the nonvolatile memory, and
wherein the address map maps the logical addresses to physical addresses of all of the sub memory blocks other than the at least one of the sub memory blocks that comprises the pre-programmed memory cells configured with management data.

16. The device of claim 15, wherein each of the memory cells comprises an array of transistors, the special memory block has rows of cell strings and columns of cells strings, each of the cell strings includes a respective one of the transistors from each of the memory cells, and the transistors of each of the cell strings are electrically connected to each other.

17. The device of claim 16, further comprising a read and write circuit configured to read data from the memory blocks and write data to the memory blocks of the memory cell array, and bit lines connecting the read and write circuit to the memory cell array, wherein each of the bit lines is electrically connected in common to the cells strings that constitute a respective one of the columns of cell strings of the special memory block.

18. The device of claim 17, wherein each of the cell strings further comprises a string selection transistor electrically connected to the transistors of the memory cells of the cell string, and further comprising string selection lines each electrically connected to the string selection transistors constituting the cell strings of a respective row of the cell strings.

19. The device of claim 18, further comprising word lines, and wherein each of the word lines is electrically connected in common to the transistors of a respective one of the memory cells of the special memory block.

20. The device of claim 18, wherein each of the cell strings comprises a respective pillar extending upright on the substrate and electrically connecting the transistors of the cell string to a respective one of the bit lines.
